(19) United States
(12) Patent Application Publication
(10) Pub. No.: US 2019/0113069 A1
(43) Pub. Date: Apr. 18, 2019

(54) FASTENER WITH FREELY ROTATING COVER

(71) Applicant: Red Flag Cargo Security Systems LLC, Milwaukee, WI (US)

(72) Inventors: Gregory Kleynerman, Fox Point, WI (US); Charles P. Lord, Niles, MI (US)

(73) Assignee: Red Flag Cargo Security Systems LLC, Milwaukee, WI (US)

(21) Appl. No.: 15/786,666

(22) Filed: Oct. 18, 2017

(51) Int. Cl. F16B 39/10

(52) U.S. Cl. CPC F16B 39/105

(57) ABSTRACT

A fastener comprises a cover, a head, a threaded shaft, and a snap ring, the fastener being adapted to secure a valuable item to a support. The snap ring is received within a cover groove and a head groove, so that a portion of the snap ring is received in both of the cover groove and the head groove, and the cover is locked in place over the head, the cover being free to rotate relative to the head.

### FIELD OF THE INVENTION

The present disclosure relates generally to tamper proof locks and fittings and more particularly to tamper proof service bolts for protecting valuable items.

### BACKGROUND OF THE INVENTION

Often it is necessary to attach valuable items to outdoor equipment. When left unattended, thieves may attempt to remove the valuable items from the outdoor equipment. When the best and only way to attach the valuable equipment to the outdoor equipment is with a bolt or nut, it is relatively easy for the bolt or nut to be removed and the valuable item removed from the outdoor equipment. For example, a valuable compressed air connector is often attached to a train car by attaching with a bolt the compressed air connector to a plate extending from the train car.

What is needed is a way to attach the valuable item to the plate so that it cannot be easily removed from the plate.

### SUMMARY OF THE INVENTION

Disclosed is a fastener comprises a cover, a head, a threaded shaft, and a snap ring, the fastener being adapted to secure a valuable item to a support. The snap ring is received within a cover groove and a head groove, so that a portion of the snap ring is received in both of the cover groove and the head groove, and the cover is locked in place over the head, the cover being free to rotate relative to the head.

### BRIEF DESCRIPTION OF THE DRAWINGS

FIG. 1 is a cross-sectional view of a fastener cover according to this disclosure.

FIG. 2 is in end view of the cover shown in FIG. 1.

FIG. 3 is a partial side view of a threaded shaft with a nut according to this disclosure passing through a hole in a valuable item and a plate.

FIG. 4 is an end view of a fastener head shown in FIG. 3.

FIG. 5 is a front view of a snap ring according to this disclosure.

FIG. 6 is a partial side view of the cover over the nut, with the snap ring received in both a cover groove and a nut groove.

Before one embodiment of the disclosure is explained in detail, it is to be understood that the disclosure is not limited in its application to the details of the construction and the arrangements of components set forth in the following description or illustrated in the drawings. The disclosure is capable of other embodiments and of being practiced or being carried out in various ways. Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof. Further, it is to be understood that such terms as “forward”, “rearward”, “left”, “right”, “upward”, “downward”, “side”, “top” and “bottom”, etc., are words of convenience and are not to be construed as limiting terms.

### DETAILED DESCRIPTION

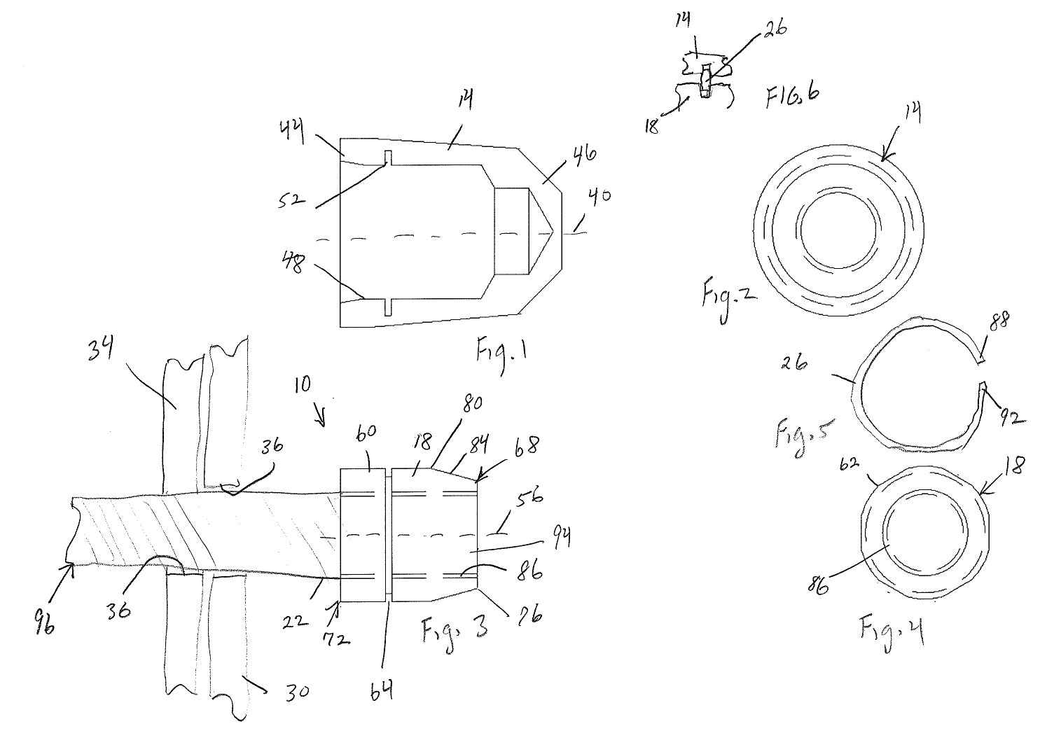

As illustrated in FIGS. 1-6, a fastener 10 comprises a cover 14, a head 18, a threaded shaft 22, and a snap ring 26. The fastener 10 is adapted to secure a valuable item 30 to a support 34, such as a plate, both the valuable item and the support having a hole 36 there through. In some embodiments, the valuable item 30 is an air compressor for attachment to a rail car. In other embodiments, the valuable item can be anything of value, including a another plate, the two plates being held together by the fastener 10 to protect valuable items accessible by separating the plates, like when the plates hold closed a door to a storage area.

The cover 14 has an elongated axis 40, with an open cover end 44, and a closed cover end 46. In other embodiments (not shown), both ends may be open. The cover 14 also has an inside surface 48. The majority of the cover outside and surfaces are round. The inside surface 48 of the cover 14 also has an annular groove 52 extending at least partially around the cover inside surface 48, generally perpendicular to the cover elongated axis 40.

The head 18 is either a bolt head or a threaded nut, with an elongated central axis 56. The outside surface 60 of the head 18 has radially outward extending points 62 or extensions that are adapted to aid in the turning of the head 18 by being capable of being engaged by hand or with the use of a tool (not shown). In some other embodiments (not shown), the head outer surface may alternatively be knurled to aid in the turning of the head 18.

In the illustrated embodiment, the head 18 has at least eight flats therein so that the head 18 can be engaged by an appropriately sized socket wrench (not shown) adapted to turn the head 18. The head 18 also has a first head end 68 and second head end 72, with the first head end 68 having a first diameter outer surface 76, increasing in diameter to a second diameter 80 as the outer surface 60 extends away from the first head end 68, thereby forming a ramp 84 adapted to expand the snap ring 26 as the snap ring 26 slides over the head 18, as explained below.

Further, the head 18 may or may not assist with turning the threaded shaft 22, as explained below.

The threaded shaft 22 is adapted to cooperate with the head 18, the head second end 72 being adapted to be secured to the threaded shaft 22. In the illustrated embodiment, the head 18 is in the form of a nut that has a threaded opening 86 there through along the central axis 56 of the head 18. In other embodiments (not shown), the head can be the head of a bolt, attached to the threaded shaft. In the illustrated embodiment, the majority of the shaft is threaded. In other embodiments (not shown), only a portion of the shaft may be threaded for being received in a like threaded opening (not shown) in the support or valuable item. In still other embodiments (not shown), only the portion of the shaft receiving a like threaded nut may be threaded. For example, the threaded shaft may be welded to a support, and the valuable item secured between the head 18 and the support 34 by threading the nut on the threaded end of the shaft.

The threaded shaft 22 may be adapted to be turned to either be secured (not shown) in a like threaded opening, or held by another like threaded nut, or may be secured to the support or valuable item by welding, for example, or by the shaft having a bolt head on the end opposite the end of the shaft that receives the fastener head, or some other similar feature.

The hole in the support 34 may be a blind hole, or a through hole 36. The threaded shaft 22 has a first shaft end 94 and a second shaft end 96, and the shaft 22 can be secured in the hole at one or both ends (not shown), or by virtue of the threaded shaft being held (not shown) in a like threaded opening in either the support or the valuable item.

The head 18 also has a head groove 64 extending at least partially around the outside surface 60 of the head 18. The head groove 64 is generally perpendicular to the longitudinal central axis 56 of the head 18.

The snap ring 26 is annular, with the a first ring end 88 and a second ring end 92, with a space between the ends, as shown in FIG. 5. This permits the annular diameter of the snap ring 26 to be decreased (compressed) by having the ends brought together, such as when the snap ring 26 is compressed to be placed inside the cover 14 to where the snap ring 26 is aligned with the cover groove 52, and then expanded so that it stays inside the cover groove 52. The snap ring diameter can also be increased (expanded) by having the ends brought away from each other, such as when the snap ring 26 slides over the head 18, as further explained below.

The snap ring 26 is received within the cover groove 52. Before the cover 14 is placed over the head 18, the snap ring 26 is retained in the cover groove 52 but the snap ring diameter is such that the snap ring diameter can be increased further, when the cover 14 is slid over the head 18, as explained below.

The cover groove 52 is spaced apart from the cover open end 44. With the snap ring 26 received within the cover groove 52, and when the cover 14 is slid over the head 18, the reduced diameter snap ring 26 first engages the head outside surface ramp 84 at the first head end 68. As the cover 14 continues up the ramp 84, the snap ring 26 expands to where it can be received within the head groove 64. After being received in the head groove 64, the snap ring 26 returns to its smaller diameter shape, but a portion of the snap ring 26 is still received within the cover groove 52. With the snap ring 26 thus received in both of the cover groove 52 and the head groove 64, as illustrated in FIG. 6, the cover 14 is locked in place over the head 18. And the cover 14 is free to rotate relative to the head 18. Thus, rotating the cover 14 does not serve to move the threaded shaft 22 or the head 18 relative to the shaft 22.

Expressed another way, since the cover 40 is round, the cover 40 turns freely on the head 18, and the cover 40 is over the head 18, a wrench or socket (not shown) cannot be placed on the head 18 to cause the head 18 to turn. This results in the prevention of the easy disassembly of the fastener 10 from its valuable item 30 attached to the support 34, thereby deterring the valuable item's theft. The cover 14 and head 18 may be torched or cut off, but this process is much more difficult than the mere turning and removal of the head 18. Thus, this fastener deters the theft of the valuable item 30.

Various other features of this disclosure are set forth in the following claims.

1. A fastener comprises a cover, a head, a threaded shaft, and a snap ring, the fastener being adapted to secure a valuable item to a support, both the valuable item and the support having a hole there through,
the cover having an longitudinal axis, with an open cover end, an inside surface, and an annular cover groove extending at least partially around the cover inside surface, generally perpendicular to the cover longitudinal axis, the cover groove being spaced apart from the cover end,
The head having an longitudinal central axis, an outside surface adapted to aid in the turning of the head, a head groove extending at least partially around the outside surface of the head, the head groove being generally perpendicular to the longitudinal central axis of the head, a first head end and a second head end, with the first head end having a first diameter, increasing in diameter to a second diameter as the outer surface extends away from the first end, thereby forming a ramp,
the threaded shaft being adapted to cooperate with the head, the head second end being adapted to be secured to the threaded shaft, and
the snap ring being annular, with a first ring end and a second ring end, with a space between the first and second ring ends so that the diameter of the snap ring can be decreased by having the first and second ring ends brought together, and the snap ring diameter can be increased by having the first and second ring ends brought away from each other,
the snap ring being adapted to be received within the cover groove, but with a portion of the snap ring extending radially inward of the cover inner surface so that the snap ring can be engaged by the nut ramp and expanded, so that
when the cover is slid over the head, the reduced diameter snap ring first engages the head outside surface ramp at the first end of the head, and as the cover continues up the ramp, the ring expands to where it can be received within the head groove, and after being received in the head groove, the snap ring returns to its smaller diameter shape, so that a portion of the snap ring is received in both of the cover groove and the head groove, and the cover is locked in place over the head, the cover being free to rotate relative to the head.

2. The fastener of claim 1 wherein the head is a threaded nut adapted to be threaded onto the threaded shaft.
